(19) United States
(12) Patent Application Publication
(10) Pub. No.: US 2002/0009659 A1
(43) Pub. Date: Jan. 24, 2002

(54) IMAGE FORMING PROCESS

(76) Inventors: KATSUJI EBISU, KANAGAWA (JP); TAKAHIRO KASHIKAWA, KANAGAWA (JP); TOMOAKI TANAKA, KANAGAWA (JP); NORIO SAWATARI, KANAGAWA (JP); TAKESHI OGINO, KANAGAWA (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(21) Appl. No.: 09/252,235

(22) Filed: Feb. 18, 1999

Related U.S. Application Data
(63) Continuation-in-part of application No. 08/665,704, filed on Jun. 18, 1996, now abandoned.

(30) Foreign Application Priority Data
Aug. 24, 1995 (JP) 7-216161

(51) Int. Cl. G03G 13/20

(52) U.S. Cl. 430/45; 430/107.1; 430/124; 430/109.4; 430/111.41

(57) ABSTRACT

The binder resin used for color toner is a polyester resin comprising a mixture of a polyvalent carboxylic acid with a specific dicarboxylic acid, and a dihydric alcohol component.

### BACKGROUND OF THE INVENTION

1. Field of the Invention

The present invention relates to an image forming process using multi-color electrophotography. The present invention further relates to an improved developing method for the image forming process, which developing method may be applied not only to multi-color but also to single-color electrophotography.

2. Description of the Related Art

Multi-color images using electrophotography are usually realized by utilizing toners with the 3 colors yellow, magenta and cyan, and overlaying toner images of each color for color mixture. Color toner, however, requires certain properties characteristic to color toner and not conventional black toner, which have presented the following problems.

Electrophotography employed for copying machines, laser printers and the like generally involves imparting a uniform electrostatic charge to a photoconductive insulating layer and irradiating a light image on the insulating layer to partially remove the electrostatic charge and form an electrostatic latent image, and then adhering a fine powder, known as toner, onto the remaining sections of the electrostatic charge to form (develop) a visible toner image from the latent image, and thermally fixing the toner image onto recording paper to obtain a print.

A number of different fixing systems are known for the above-mentioned fixing method, but because of its particularly high thermal efficiency and lack of danger by fire, the most widely utilized system is the heated roll fixing system which comprises a rotatable heated roller with an internal heat source, and a pressure roller which rotates while in contact with the above-mentioned heated roller, wherein aluminum rollers are usually used as both of the above-mentioned rollers.

When alumina rollers are used, however, their high hardness results in roughening of the fixed image surface after hot melting of the toner, thus impairing the smoothness thereof, and even with monochrome printing irregularities are produced on the solid black image surface when printing graphics and the like, and thus impaired image quality becomes a problem. This has been a particular problem with printing of images of natural scenes, etc. using color toner, where high smoothness is desired for the fixed image. Although for improved smoothness of the fixed images it is preferred to reduce the roller hardness using silicone rubber, etc. as the roller material, the use of silicone rubber tends to result in scraping of the surface of the silicone rubber by contact with the toner, paper, etc., thus creating drawbacks of roughening of the roller surface and thus a shorter usable life. In order to improve the durability of the roller surface alone without too great a reduction in the roller hardness, rollers made of silicone rubber coated with a fluororesin are used as fixing rollers for improved durability while maintaining satisfactory image smoothness. Nevertheless, a problem remains in greater proneness to offsetting, and a narrower fixing temperature margin. Especially in the case of color toner for which image smoothness is important, the low viscoelasticity of the toner poses a greater problem of offsetting than with conventional black toner.

Polyester resins are generally used as color toner binder resins because of their low index of refraction, and since polyester resins with linear structures have especially low viscoelasticity, and thus provide excellent smoothness of fixed image surfaces, they have been the main type of binder resins used for color toner. However, though satisfactory fixability is achieved on soft rollers when linear polyester resins are used, when they are fixed on semi-soft rollers used for high-speed color printing their non-offsetting properties have been problematically poor. Gel components have therefore been introduced into polyester resins for improved non-offsetting properties, though these have not provided smooth fixed images. Thus, there have been no color toner binder resins which are able to provide both non-offsetting properties and smoothness of fixed image surfaces.

The above-mentioned hot roll fixing devices have been widely realized by heated roll fixing systems which comprise a rotatable heated roller with an internal heat source, and a pressure roller which rotates while in contact with the above-mentioned heated roller, and aluminum rollers are usually used as both of the above-mentioned rollers. When alumina rollers are used, however, their high hardness results in roughening of the fixed image surface after hot melting of the toner, thus impairing the smoothness thereof, and even with monochrome printing irregularities are produced on the solid black image surface when printing graphics and the like, and thus impaired image quality becomes a problem. This has been a particular problem with printing of images of natural scenes, etc. using color toner, where high smoothness is desired for the fixed image. Although for improved smoothness of the fixed images it is preferred to reduce the roller hardness using silicone rubber, etc. as the roller material, the use of silicone rubber tends to result in scraping of the surface of the roller by contact with the toner, paper, etc., thus creating drawbacks of roughening of the roller surface and thus a shorter usable life, and therefore it has been difficult to apply them to high-speed printers which have a short exchange cycle. In addition, in order to improve the durability of the roller surface alone without too great a reduction in the roller hardness, rollers made of silicone rubber coated with a fluororesin are used as fixing rollers for improved durability while maintaining satisfactory image smoothness. Nevertheless, with the poorer non-offsetting properties, it has been necessary to improve the non-offsetting properties from the toner end. Conventional toner with improved non-offsetting properties, however, provides inferior image smoothness with soft roller fixing; consequently, there has been no color toner which is capable of achieving satisfactory non-offsetting properties with semi-soft roller fixing devices while maintaining satisfactory smoothness with soft roller fixing.

It is a first object of the present invention to realize satisfactory smoothness and non-offsetting properties with semi-soft roller fixing devices. The is following additional problem has existed with color toner, which requires certain properties characteristic to color toner and not conventional black toner.

The major pigments used in yellow toners have been benzidine-based pigments, but benzidine-based pigments carry the danger of producing a carcinogenic substance (dichlorbenzidine) at high temperatures (200° C.), while the use of safe pigments with other structures, such as isoindolinone-based pigments and benzimidazolone-based pigments, results in poor colorability and large toner charge variation during continuous printing, for which reasons stable developing properties have not been achieved.

Although the colorability is good when quinacridone-based pigments, naphthol-based pigments and azo lake pigments are used as magenta pigments, they produce large toner charge variation during continuous printing, and thus stable developing properties have not been achieved.

Good colorability is also obtained when copper phthalocyanine pigments are used as cyan pigments, but they also produce large toner charge variation during continuous printing, and thus stable developing properties have hot been achieved.

The cause of these problems is that the pigment particles in the toner are large causing more of the pigment to be exposed on the toner surface, and toner filming on the carrier surface due to the pigment hampers continuous printing, while the large pigment particles reduce the transparency, making it impossible to obtain clear colorability.

In addition, in the case of color electrophotography, fluctuations in the adhering amount (developing amount) of the color toner causes wide variations in the color toner of the printed product, and therefore since with color toner it is essential to realize a stable developing amount after continuous printing even under environmental changes, stable printing characteristics have riot been possible using color developers with fluctuating charge amounts as mentioned above.

Metal complexes such as chrome and zinc complexes have commonly been used as conventional charge control agents for color toner, but despite their favorable charge-imparting effect, it is possible that metal complexes will be regulated in the future due to environmental problems, for which reason it is desirable to switch to metal-free charge control agents. Resin charge control agents, on the other hand, have the disadvantage of a low charging effect, as do calixarenes when used in common color toners according to normal methods, and therefore colorless charge control agents which are metal-free and have a charge-imparting effect have not existed in the prior art.

Additives to color toner include hydrophobic silica powder, titanium dioxide powder and the like, and while hydrophobic silica powder has a considerable effect of improving toner fluidity, it undergoes large charge amount fluctuations along with environment changes (especially humidity changes). On the other hand, although titanium dioxide powder has the effect of reducing charge fluctuations with environment changes, its improving effect on toner fluidity is small. Also, mixtures of hydrophobic silica powder and titanium dioxide powder have a fluidity-improving effect, but also have the disadvantage of not allowing reduction in charge fluctuations with environmental changes.

Thus, no color developing agents for color toner have existed with all of the desired characteristics of excellent colorability, charge stability with environment changes and image stability during continuous printing.

Furthermore, when high-stability benzimidazolone-based pigments are used as yellow pigments, their color phase shifts toward red as compared with most widely used benzimidazolone-based pigments, thus creating the problem of color balance shifts when common quinacridone-based pigments are used as magenta pigments.

It is a second object of the present invention to provide an image forming process capable of stably supplying clear full-color images over long periods of time even under changing environmental conditions.

### DETAILED DESCRIPTION OF THE INVENTION

Aspect 1 (toner binder resin)

The first object of the invention is accomplished by the first aspect of the invention which is that of providing an image forming process using multi-color electrophotography comprising the step of thermal fixing using a semi-soft roller made by coating the surface of a roller substrate with silicone rubber to a thickness of 2-30 mm and further coating that surface with a fluororesin, the image forming process using multi-color electrophotography being characterized in that the binder resin of the color toner is a polyester resin which comprises an alcohol component and an acid component, of which the alcohol component is a dihydric alcohol and the acid component comprises a polyvalent carboxylic acid and at least one selected from dicarboxylic acids represented by the following general formulas:

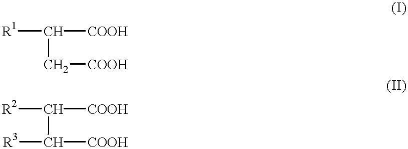

wherein R¹, R² and R¹ are saturated or unsaturated hydrocarbon groups of 6-24, preferably 10-20 and especially about 12 carbon atoms, and their acid anhydrides.

Binder resins used in color toners for forming images with hot roll fixing devices by multi-color electrophotography comprise an alcohol component and an acid component, and by using as the color toner binder resin a polyester resin of which the alcohol component is a dihydric alcohol and the acid component consists of a polyvalent carboxylic acid and a dicarboxylic acid represented by the general formula (I) or (II) (wherein R¹, R² and R¹ are saturated or unsaturated hydrocarbon groups of 6-24 carbon atoms) or an acid anhydride thereof, the monomers represented by formula (I) or (II) form long side chains, and these long side chains become tangled without bonding to thus form a pseudo-crosslinked structure. The tangling of the side chains provides optimum dynamic viscoelasticity, to thus realize satisfactory image smoothness with soft roller fixing and satisfactory non-offsetting properties with semi-soft roller fixing.

In addition, optimization of the dynamic viscoelasticity of the toner is facilitated by using terephthalic acid or its anhydride as the above-mentioned polyvalent carboxylic acid. Optimization of the dynamic viscoelastictty of the toner is also facilitated by using trimellitic acid or its anhydride as the above-mentioned polyvalent carboxylic acid.

Optimization of the dynamic viscoelasticity of the toner is also facilitated by using a compound represented by the following general formula (III) as the above-mentioned dihydric alcohol.

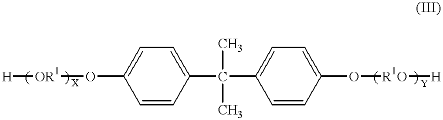

wherein R⁴ represents an alkylene group of 2-4 carbon atoms, with an average value of the total number of carbon atoms of R⁴ being 2-16.

Also, when the dicarboxylic acid represented by the above formula (I) or (II) or its anhydride constitutes less than 10 mole percent of the acid component, the pseudo-crosslinking effect is not obtained and poor non-offsetting properties are exhibited in semi-soft roller fixing devices. When the dicarboxylic acid represented by the above formula (I) or (II) or its anhydride constitutes greater than 80 mole percent of the acid component, the image smoothness with soft roller fixing devices is impaired. If the chloroform-insoluble portion of the above-mentioned polyester resin is greater than 20 wt % of the polyester resin, the dynamic viscoelasticity becomes too high, thus impairing the image smoothness with soft roller fixing devices.

Satisfactory characteristics may be maintained even when the above-mentioned polyester resin is used in admixture with a conventional linear polyester resin.

The toner to be used for the first aspect of the invention is not limited, and generally the ones indicated below are suitable.

The following coloring materials may be used for color toner.

Examples of benzidine-based organic pigments which may be used according to the invention include, by Color Index No., C.I. 21090 (pigment yellow 12, KET Yellow 406, Dainippon Ink Kagaku Kogyo), C.I. 21095 (pigment yellow 14, KET Yellow 404, Dainippon Ink Kagaku Kogyo), C.I. 21100 (pigment yellow 13, KET Yellow 405, Dainippon Ink Kagaku Kogyo), etc. These pigments have excellent dispersability in binder resins and satisfactory spectral reflection characteristics.

A quinacridone-based organic pigment which may be used according to the invention is, by Color Index No., C.I. 73916 (pigment red 122, KET Red 309, Dainippon Ink Kagaku Kogyo). This pigment has excellent dispersability in binder resins and satisfactory spectral reflection characteristics.

A rhodamine-based organic pigment which may be used according to the invention is, by Color Index No., C.I. 45160 (pigment red 81, Ultra Rose R, Toyo Ink). This pigment has excellent dispersability in binder resins and satisfactory spectral reflection characteristics.

Phthalocyanine-based organic pigments which may be used according to the invention include, by Color Index No., C.I. 74160 (pigment blue 15, KET Blue 102, KET Blue 103, KET Blue 104, KET Blue 105, KET Blue 106, KET Blue 111, Dainippon Ink Kagaku Kogyo), C.I. 74260 (pigment green 7, KET Green 201, Dainippon Ink Kagaku Kogyo), etc. These pigments have excellent dispersability in binder resins and satisfactory spectral reflection characteristics.

A metal-containing dye, a fatty acid ester or a compound with an amino group may also be added as a charge control agent.

The toner to be used for the first aspect of the invention may be produced by a conventional publicly known process. That is, the desired toner may be obtained by melting and kneading the binder resin and the pigment, if necessary with addition of a wax, charge control agent or the like, using a pressure kneader or extruder, and then uniformly dispersing the mixture and sorting it with, for example, an air classifier or the like.

Aspect 2 (color toner)

The second object of the present invention is accomplished by the second aspect of the invention which is that of providing an image forming process for forming images through heated roll fixation by multi-color electrophotography, using the 3 colors of yellow toner, magenta toner and cyan toner, or these 3 color toners with black toner, which comprise a binder resin, a charge control agent, a coloring agent and an exterior additive, the image forming process by multi-color electrophotography being characterized in that

the yellow pigment used as the coloring agent of the yellow toner is a benzimidazolone-based pigment which is dispersed in the yellow toner at an average particle size of 1 μm or less, and the toner uses titanium dioxide powder surface treated with a silane coupling agent as an exterior additive;

the magenta pigment used as the coloring agent of the magenta toner is dispersed in the magenta toner at an average particle size of 1 μm or less, and the toner uses titanium dioxide powder surface treated with a silane coupling agent as an exterior additive;

the cyan pigment used as the coloring agent of the cyan toner is dispersed in the cyan toner at an average particle size of 1 μm or less, and the toner uses titanium dioxide powder surface treated with a silane coupling agent as an exterior additive; and

the charge control agent is a calixarenes.

Dispersing the color toner coloring agent in the toner at an average particle size of 1 μm or less improves the colorability, while also preventing exposure of the pigment on the toner surface, and therefore when a two-component developing agent was used, toner filming on the carrier surface was minimized, thus reducing toner charge fluctuations. In addition, the use of titanium dioxide powder surface treated with a silane coupling agent as an exterior additive resulted in reduced toner charge fluctuation even with changes in environmental humidity between 20-80% RH (25° C.). Furthermore, replacing the conventional benzidine-based pigment with a benzimidazolone-based pigment as the yellow pigment eliminated the risk of generating carcinogenic substances, and using a naphthol-based azo pigment for the magenta toner and a copper phthalocyanine pigment as the cyan pigment, as well as titanium dioxide powder surface treated with a silane coupling agent as an exterior additive, it was possible to reduce toner charge fluctuations even with changes in environmental humidity between 20-80% RH (25° C.). In addition, by using a calixarenes as the charge control agent in the color toner containing the microdispersed pigments and TiO₂ as an exterior additive, stable, satisfactory charge characteristics were realized even with continuous printing, while the materials used were highly safe and contained no metal elements.

By using the aforementioned yellow toner, magenta toner and cyan toner, formation of stable, clear images is possible with good color balance of the 3 colors of toner, even over extended periods of continuous printing, and even with changes in environmental humidity.

By using as the exterior additive titanium dioxide, the primary particles of which have a size of 0.001 to 0.1 μm, and the above-mentioned titanium dioxide powder adhering to the toner surface having an average particle size of 1.0 μm or less, it is possible to obtain a considerable effect of improvement in the toner fluidity and thus eliminate the use of other external additives.

By using as the exterior additive titanium dioxide powder with an electrical resistance of 1×10⁶−1×10¹², it is possible to minimize fluctuations in the electrical resistance of the toner with environmental changes, and thus reduce toner charge fluctuations.

By using an anatase-type rather than rutile-type crystalline form titanium dioxide powder as the exterior additive in the toner, it is possible to achieve stable charge characteristics over extend periods, although the reason for this is not clear.

Titanium dioxide powder with n-butyltrimethoxysilane as the silane coupling agent used for the coating agent has little association between primary particles while the particle size of the secondary particles is not very large, and this provides a considerable effect of improvement in the toner fluidity.

If the titanium dioxide powder is added to the toner in an amount less than 0.1 wt % it will have a small effect as an exterior additive, and the charge characteristics will be poor. Conversely, if it exceeds 2 wt % scattering of the toner will increase, creating the problem of contamination inside the apparatus.

The calixarenes to be used for the second aspect of the present invention is a compound represented by

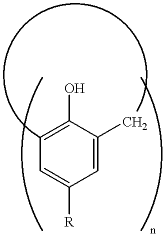

or a derivative thereof. The derivative may be one in which the hydrogen atom of the benzene ring, methylene group or hydroxyl group or R is substituted with a substituent (especially a lower alkyl, aryl, aralkyl, halogen, etc.), or a copolymer of such a derivative (see Japanese Unexamined Patent Publication No. 2-201378).

Also, if the charge control agent is added to toner at less than 0.1 wt %, the charge-imparting effect will be reduced, resulting in poor charge characteristics. Conversely, if it exceeds 5 wt % the charge stability will be impaired.

The toner used for the second aspect of the present invention may also be produced by a conventional publicly known process. That is, the desired toner may be obtained by melting and kneading the binder resin and the pigment, if necessary with addition of a wax, charge control agent or the like, using a pressure kneader or extruder, and then uniformly dispersing the mixture and sorting it with, for example, an air classifier or the like.

Aspect 3 (developing agent)

According to the third aspect of the present invention, there is provided an electrophotographic developing process characterized in that the developing agent used is a two-component developing agent comprising toner and a magnetic carrier wherein, substituting the data from measurement of the toner charge amount¦q(t)¦(μC/g) at agitation time t (sec) taken at 6 or more points (n times), including data measured at 0 seconds and at points between 0-30 seconds, 30-60 seconds, 60-120 seconds and 120-300 seconds, into the following equation (1):

¦q(t)¦=aτ−bτ·exp(−ct)/(cτ−1)−d·exp(−t/τ) (1)

and upon calculating the constants a, b, c, d and τ by the least square method, with an x² distribution for the degree of freedom (ν=n−5)

$${F}_{υ} ( {χ}^{2} ) = {\int }_{{x}^{2} α}^{∞} {f}_{υ} ( {χ}^{2} ) ⅆ {χ}^{2} = α$$

$$wherein$$

$${f}_{υ} ( {χ}^{2} ) = \frac{{( {χ}^{2} )}^{υ / 2 - 1} {ⅇ}^{- {χ}^{2} / 2}}{{2}^{υ / 2} Γ ( υ / 2 )}$$

χ² is no greater than the value χ²_{0.05} at α=0.05, and¦q′(0)¦ represented by the following equation (2)

¦q′(0)¦=bcτ/(cτ−1)+d/τ (2)

is 1 μC/g•sec or greater.

A process for developing toner by electrophotography which is in particularly wide use is the magnetic brush developing process described in U.S. Pat. No. 2,786,439. Here, the amount of charge in the toner, i.e. the toner charge amount, has a large effect on the developing characteristics. With two-component developing agents, toner is added to the developing agent from a toner hopper in order to supplement the consumed toner when it is consumed by printing, and the added toner is electrified by friction with the carrier in the developing agent, producing a charge which contributes to the development. However, when the added toner is not immediately charged by friction with the carrier (when the charging rate is slow), this weakens the force holding it to the toner carrier, and thus allows the added toner to separate from the carrier, leading to scattering of the toner and thus contamination inside the apparatus.

Furthermore, although the toner is charged by friction with the carrier upon agitation, the toner charge amount varies at times depending on the agitation time, and fluctuations in the charge amount over a wide range have caused problems of greater variation in the image characteristics.

Another area of concern has been environmental conditions, particularly the humidity conditions, at the location of the printer, since developing agents with large toner charge fluctuations due to changes in humidity have had the disadvantage of larger variation in image characteristics upon changes in the environmental conditions.

In the case of color electrophotographs, fluctuations in the adhering amount (developing amount) of color toner causes large variations in color tone of the printed product, and therefore with color toner it is essential to achieve a stable developing amount even after continuous printing or under environmental changes; since the above-mentioned color developing agents which undergo charge amount variations cannot provide stable printing characteristics, color developing agents have especially been desired which do not result in fluctuations of the toner charge amount.

The third aspect of the present invention meets this demand, and the present inventors have discovered, as a result of much research regarding the above-mentioned problems of the prior art, that using a developing agent which satisfies the condition of having a constant toner charge amount with respect to the stirring time, constitutes a developing agent which enables realization of a fast toner charging rate and stable charge characteristics.

Thus, it was found that all of the aforementioned problems may be overcome by using the above-mentioned developing agent. The measurement is made within the times mentioned above because the stirring time dependence of the charge amount is characteristically larger within those times, whereas the stirring time dependence of the charge amount which is unique to each developing agent cannot be determined if the measurement is not within those times.

The background to the derivation of the equations given above will now be explained.

The stirring time dependence of the toner charging rate has been analyzed as a model divided into “generation rate” and “charge leak rate”, and has been represented by the following equation (3) [Karakita: 60th Research Forum of the Electrophotography Assoc., p.1 (1987); Matsui: Journal of the Electrophotography Assoc., 27, (3), p.307 (1988)].

¦q′(t)¦k(Φ_{T}−Φ_{C})−q(t)/τ (3)

Here, (Φ_{T}−Φ_{C}) is the work function difference between the toner and the carrier, and τ is the time constant of charging.

Solving for the differential equation of equation (3) yields equation (4).

¦q(t)¦=kτ(Φ_{T}−Φ_{C})−d·exp(−t/τ) (4)

Here, d is the positive integral constant.

In the above charge behavior model equation (1), the generation rate for electrical generation is believed to be simply proportional to the work function difference between the toner and carrier, without variation based on the stirring time, and it is thus represented by the constant k(Φ_{T}−Φ_{C}). With two-component developing agents, however, the surface condition of the toner and carrier vary with the stirring time, and thus the work function difference between the toner and carrier is also believed to change with time, for which reason the following equation was constructed for the electrical generation as a function of time¦f(t)·.

¦f(t)¦=a+b·exp(−ct/τ) (5)

Here, “a” is the generation rate at equilibrium of the surface condition upon stirring of the toner and carrier (corresponding to the generation rate when t=∞ (k₁((Φ_{T1}−Φ_{C1})), and “b” is the difference in the generation rates at t=0 and t=∞, i.e. the degree of reduction in the generation rate, and “c” corresponds to the rate up until equilibrium of the surface condition of the toner and carrier.

Replacing equation (4) for the generation rate in equation (3) yields equation (6).

$$\begin{matrix}\vert {q}^{∝} ( t ) \vert = f ( t ) - q ( t ) / τ \\ = a + b \cdot exp ( - ct / τ ) - q ( t ) / τ\end{matrix} \qquad ( 6 )$$

Solving for the differential equation of equation (6) yields equation (1) given above.

¦q′(t)¦=aτ−bτ·exp(−ct)/(cτ−1)−d·exp(−t/τ) (1)

The χ² test (Yoshisawa, Y., New Theory of Errors, Kyoritsu Publ. Co.) was used to examine the experimental data to determine whether or not it was compatible with the model equation.

The variable χ² is calculated, for example, by measuring the time dependence of the toner charge amount and inserting the data into equation (1), at the time of calculating the constants (a, b, c, d and τ) by the least square method, and the compatibility between the measured data and the model equation may be judged based on the value of χ².

The variable χ² may be expressed by the following equation (7) (p. 198, Yoshisawa, Y., New Theory of Errors, Kyoritsu Publ. Co.).

$${χ}^{2} = {\sum }_{i = 1}^{n} {\frac{1}{{σ}_{i}^{2}} [ {y}_{i} - y ( {x}_{i} ) ]}^{2} \qquad ( 7 )$$

y(xᵢ) is a “p” exponent polynomial represented by equation (8), and when the coefficient p+1 is calculated by the least square method, χ² follows the χ² distribution for the degree of freedom ν=n−(p+1)[equation (9)].

y=a+bX+cX+ . . . +kX^{r} (8)

In the χ² distribution for the degree of freedom (ν),

$${F}_{υ} ( {χ}^{2} ) = {\int }_{{x}^{2} α}^{∞} {f}_{υ} ( {χ}^{2} ) ⅆ {χ}^{2} = α$$

$$wherein$$

$${f}_{υ} ( {χ}^{2} ) = \frac{{( {χ}^{2} )}^{υ / 2 - 1} {ⅇ}^{- {χ}^{2} / 2}}{{2}^{υ / 2} Γ ( υ / 2 )}$$

In general, if χ² is no greater than the value χ²_{0.05} at α=0.05, then the model and the experimental data are believed to be compatible, and according to the invention as well, χ² is no greater than the value χ²_{0.05}) at α=0.05 so that the experimental data and the model equation are assumed to be compatible; furthermore it was found that when the developing agent used has an initial charging rate¦q′(0)¦ represented by equation (2) of 1 μC/g•sec or greater, the toner and carrier undergo immediate frictional charging when toner is supplied to the developing agent from the toner hopper, and thus display excellent characteristics of holding a suitable toner charge without scattering of the toner.

¦q′(0)¦=bcτ/(cτ−1)+d/τ (2)

With a two-component developing agent comprising a toner and a magnetic carrier, substituting the data from measurement of the toner charge amount¦q(t)¦(μC/g) at agitation time t (sec) taken at 6 or more points (n times), including data measured at 0 seconds and at points between 0-30 seconds, 30-60 seconds, 60-120 seconds and 120-300 seconds, into the following equation with constants a, b, c, d and τ calculated by the least square method,

¦q(t)¦=aτ−bτ·exp(−ct)/(−cτ−1)−d·exp(−t/τ) (1)

with an χ² distribution for the degree of freedom (ν=n−5)

$${F}_{υ} ( {χ}^{2} ) = {\int }_{{x}^{2} α}^{∞} {f}_{υ} ( {χ}^{2} ) ⅆ {χ}^{2} = α$$

$$wherein$$

$${f}_{υ} ( {χ}^{2} ) = \frac{{( {χ}^{2} )}^{υ / 2 - 1} {ⅇ}^{- {χ}^{2} / 2}}{{2}^{υ / 2} Γ ( υ / 2 )}$$

if χ² is no greater than the value χ²_{0.05} at α=0.05, then the experimental data and the model equation are compatible, and when the developing agent used has an initial charging rate¦q′(0)¦ represented by equation (2) derived from the model equation of 1 μC/g•sec or greater, the toner and carrier undergo immediate frictional charging when toner is supplied to the developing agent from the toner hopper, and thus display excellent characteristics of holding a suitable toner charge without scattering of the toner.

¦q′(0)¦=bcτ/(cτ−1)+d/τ (2)

With the above-mentioned two-component developing agent used as the developing agent, when data from 10 measurements of the toner charge amount at agitation times of 0 seconds and at points between 0-10 seconds, 10-20 seconds, 20-30 seconds, 30-60 seconds, 60-120 seconds, 120-240 seconds, 240-480 seconds, 480-720 seconds and 720-920 seconds, are substituted into equation (1) above, and the constants a, b, c, d and τ are calculated by the least square method, then if χ² measured by the χ² test is such that χ²_{0.05}=11.07 or less, then the model equation and the experimental data have excellent compatibility, and if the¦q′(0)¦ is 1 μC/g•sec or greater, the toner and carrier undergo immediate frictional charging when toner is supplied to the developing agent from the toner hopper, and thus display excellent characteristics of holding a suitable toner charge without scattering of the toner.

With the above-mentioned two-component developing agent, if the toner charge amount is 0 when t=0 in equation (1), then the toner remains uncharged in the toner hopper and charging begins simultaneously with supply of the toner from the toner hopper to the developing device, which is advantageous for charge control of the toner.

The generation rate of the developing agent is represented by equation (5) above, and when the developing agent used has an initial generation rate f(0) represented by the equation¦f(0)¦=a+b of 1 μC/g•sec or greater, then the toner and carrier undergo immediate frictional charging when toner is supplied to the developing agent from the toner hopper, and thus the excellent characteristics are displayed of holding a suitable toner charge without scattering of the toner.

If the developing agent used has a generation rate “a” at equilibrium of the surface condition upon stirring of the toner and carrier, represented in equation (5), of 0.5 μC/g•sec or greater, then a toner charge amount will be acquirable even when the toner charge has reached equilibrium, and thus appropriate acquisition and leaking of the charge in the toner will provide satisfactory charge characteristics and therefore excellent printing characteristics without scattering of the toner.

If “b”, which is the difference in the generation rates (the degree of reduction in the generation rates) at t=0 and t=∞ represented in equation (5), is less than 0.2 μC/g•sec, then the difference between the generation rate initially and when the charge amount is saturated will be too small, thus reducing the initial charging rate, and resulting in slower charging and proneness to toner scattering. If it is greater than 2 μC/g•sec, then the difference between the generation rate initially and when the charge amount is saturated will be too large, tending to lead to unstable charge characteristics. Thus, it is preferred for “b” to be within the range of 0.2-2 μC/g•sec.

As time passes, the toner charge amount tends to increase until saturation, and then gradually decrease thereafter; the time toᵣₒ until saturation of the charge amount is the time at which¦q′(t)¦ in equation (3) becomes zero, and if tᵣₒ is 200 seconds or less, the time until saturation of charging is shortened to achieve a stable state more rapidly, and thus provide stable developing characteristics.

A large difference between the maximum value for the charge amount and the saturated charge amount qₘ (^{∞}) calculated from the equation below leads to large fluctuation in the charge amount, and in order to achieve stable developing characteristics the saturated charge amount qₘ (^{∞}) is preferably 80% or more of the maximum charge amount value.

From equation (1), qₘ (^{∞})=aτ

With two-component developing agents, the charge characteristics preferably do not vary depending on the environmental conditions, and if the developing agent is one with a tₕₒ of 0.9−1.1×tᵣₒ, tₕₒ being the time at which¦q′(t)¦ in equation (2) becomes zero, even with variation within 20-80% RH at 25° C., then the developing characteristics will undergo little variation due to the environment.

A developing agent which does not cause variation in the charge characteristics due to environment conditions must meet the following conditions when the environment conditions vary within 20-80% RH at 25° C.

χ² fluctuation within±10%

¦q′(0)¦ fluctuation within±10%

“a” fluctuation within±10%

“b” fluctuation within±10%

difference between maximum charge amount and saturated charge amount within+10%

In order to realize these satisfactory characteristics, the proportion of toner to the developing agent is preferable 1-10 wt %.

Also, in order to realize these satisfactory characteristics, titanium oxide is preferably used at 0.1-2 wt % as an exterior additive in the toner.

Also, in order to realize these satisfactory characteristics, the average particle size of the primary particles of the titanium dioxide powder is preferably 0.001-0.1 μm, and the average particle size of the above-mentioned titanium dioxide powder adhering to the toner surface (secondary particle state) is preferably 1.0 μm or less.

Also, in order to realize these satisfactory characteristics, the electrical resistance of the titanium dioxide powder is preferably 1×10⁶−1×10¹².

Also, in order to realize these satisfactory characteristics, the crystalline form of the titanium dioxide powder is preferably anatase.

Also, in order to realize these satisfactory characteristics, the silane coupling agent used as the coating agent of the titanium dioxide powder is preferably n-butyltrimethoxysilane.

Also, in order to realize these satisfactory characteristics, the charge control agent used in the toner is preferably a calixarenes.

Also, in order to realize these satisfactory characteristics, the toner used in the two-component developing agent is preferably yellow, magenta or cyan.

Also, in order to realize these satisfactory characteristics, a polyester resin is preferably used as the binder resin for the toner.

Also, in order to realize these satisfactory characteristics, the carrier used in the two-component developing agent is preferably magnetite.

Also, in order to realize these satisfactory characteristics, the carrier used in the two-component developing agent is preferably ferrite.

Also, in order to realize these satisfactory characteristics, an acryl resin is preferably used as the coating agent for the carrier used in the two-component developing agent.

Toners to be used for the third aspect of the invention may be those given for the first aspect of the invention.

### BRIEF DESCRIPTION OF THE DRAWINGS

FIG. 1 shows a multi-color image forming apparatus.

FIG. 2 shows a semi-soft roll fixing device.

FIG. 3 shows a soft roll fixing device.

### EXAMPLES

The present invention is explained below by way of examples and comparative examples which, however, are not intended to restrict the scope of the invention.

Aspect 1

[Resin Production Example 1]

A flask was loaded with 680 grams of polyoxypropylene(2,2)-2,2-bis(4-hydroxyphenyl)propane, 120 g of terephthalic acid, 100 g of tetrapropenylsuccinic anhydride and 0.1 g of hydroquinone, and then a mantle heater was used to raise the temperature to 220° C. for reaction while stirring under a nitrogen gas flow. Next, 20 g of trimellitic acid was added and the mixture was reacted for about 6 hours to produce a polyester resin. The softening point thereof was 115° C.

The method of producing the toner is outlined below.

[Toner 1 (yellow)]

| | | | |
|---|---|---|---|
| Binder resin: | Polyester resin of Production | 93.5 | pts. by wt. |
| | Example 1 | | |
| Coloring material: | Benzimidazolone-based pigment | 4 | pts. by wt. |
| | (Pigment Yellow 154) | | |
| Charge control | BONTRON E84 | 0.5 | pts. by wt. |
| agent: | (Orient Chemicals) | | |
| Wax: | Biscoru 660-P (Sanyo Kasei) | 2 | pts. by wt. |

The above composition was mixed and stirred with a ball mill and then melted and kneaded with an extruder heated to 140° C, and after cooling to solidity, a grinder was used for coarse grinding which was followed by fine grinding with a jet mill. The resulting fine powder was sorted with an air classifier to obtain toner of 5-20 μm. Titanium dioxide powder was added to this toner to 1 wt % as an exterior additive, and the exterior addition was accomplished with a Henschel mixer.

Other colored toner was prepared for testing by changing only the yellow toner pigment.

[Toner 2] Magenta toner pigment: quinacridone-based pigment, Pigment Red 122

[Toner 3 Cyan toner pigment: copper phthalocyanine pigment, Pigment Blue 15

TABLE 1
(toner composition)

| | Toner 1 | | Toner 2 | | Toner 3 | |
|---|---|---|---|---|---|---|
| Material name | (yellow) | | (magenta) | | (cyan) | |
| Binder resin | 93.5 | pts/wt | 93.5 | pts/wt | 93.5 | pts/wt |
| Charge control agent | 0.5 | pt/wt | 0.5 | pt/wt | 0.5 | pt/wt |
| Wax | 2 | pts/wt | 2 | pts/wt | 2 | pts/wt |
| Yellow pigment | 4 | pts/wt | — | | — | |
| Magenta pigment | — | | 4 | pts/wt | — | |
| Cyan pigment | — | | — | | 4 | pts/wt |
| Exterior additive | 1 | pt/wt | 1 | pt/wt | 1 | pt/wt |

(Monomer composition and physical properties of binder
resin)
Monomer composition

| | |
|---|---|
| Alcohol component | |
| (dihydric alcohol): | polyoxypropylene(2,2)-2,2- |
| | bis(4-hydroxyphenyl) |
| | propane |
| Acid component | |
| (dicarboxylic acid): | tetrapropenylsuccinic |
| anhydride [R¹ of formula | |
| (I) with 12 carbon atoms] | |
| (polyvalent carboxylic acid): | terephthalic |
| | acid (divalent) |
| (polyvalent carboxylic acid): | trimellitic acid |
| | (trivalent) |
| Chloroform-insoluble portion: | 0 wt % |

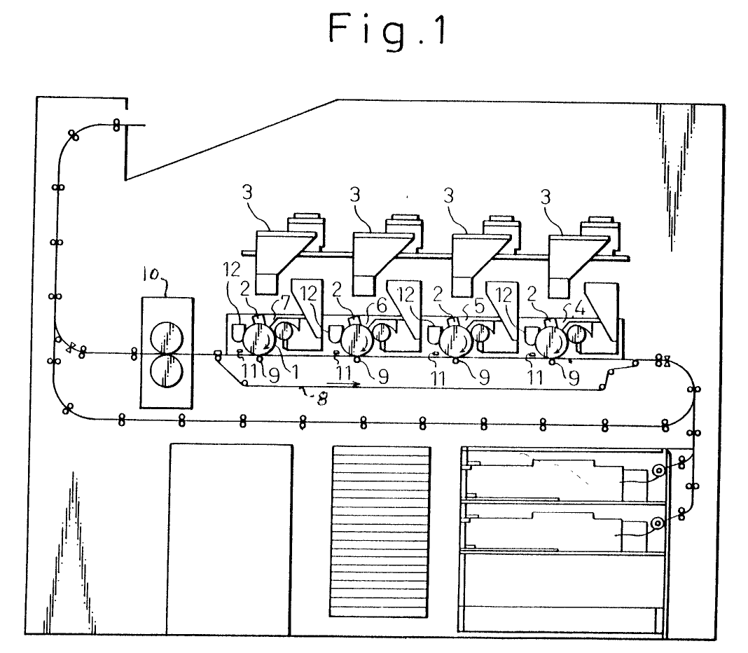

The printer indicated below was used as the apparatus for evaluation of the examples.

[Multi-color image forming apparatus (FIG. 1)]

FIG. 1 shows a rough sketch of an image forming apparatus provided with a plurality of image-forming sections for output of multi-color images.

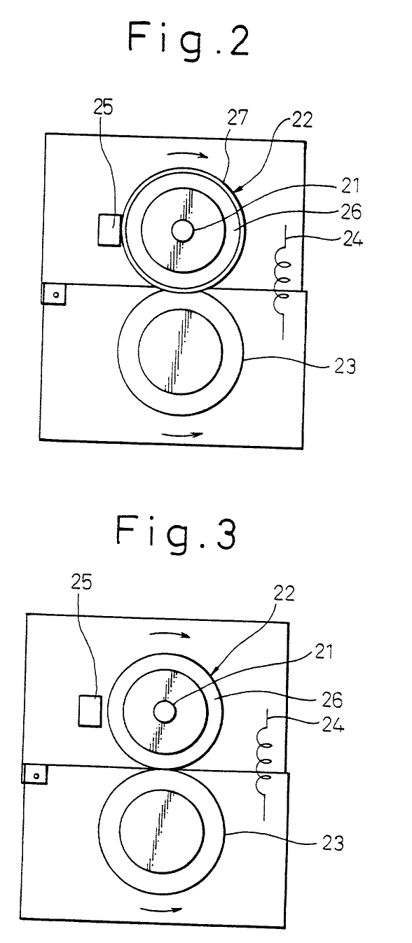

The numerals 1 indicate photosensors, and the surface of each photosensor is evenly charged by a charging device indicated by 2. The numerals 3 indicate exposure sections which project imaging light onto the surface of each photosensor according to recorded information, to form a electrostatic latent image on the photosensor surface. The numerals 4, 5, 6 and 7 are developing sections, where the electrostatic latent images formed on the photosensor are made visible using toner. The developing device develops yellow toner 4, magenta toner 5, cyan toner 6 and black toner 7. The paper conveyor belt 8 is conveyed to contact with each photosensor at the points 9, by which the visible developed toner images on the photosensors are transferred one by one onto the paper as a charge is imparted from the backside of the paper at the opposite polarity to the charge direction of the toner. The numeral 10 indicates a heated roll fixing device (shown in detail in FIG. 2), and the multi-color toner image transferred onto the paper is heated for fixation onto the paper. The numerals 11 indicate static eliminators which eliminate the residual static charge on each photosensor by LED light. The numerals 12 are cleaning sections, which remove the residual toner from each photosensor.

[Semi-soft roll fixing device (FIG. 2)]

The fixing apparatus comprises a hot roller 22 with an internal heater 21, and a pressure roller 23, and both rollers are equipped with accessory springs 24 on either side, which press the hot roller and the pressure roller together at a pressure of 2 kgf/cm². The surface of the fixing roll was coated to thickness of 50 μm with a perfluoroalkoxy resin 27 as a fluororesin, and 1 mm thick silicone rubber 26 with a rubber hardness of 30 was used as an intermediate layer between the fluororesin and aluminum roller. Felt 25 was impregnated with a fixing oil and pressure contacted with the fixing roller. The hot roll surface temperature was controlled to 160° C.

### Example 1

The above-mentioned toners 1-3 were used in combination with a carrier which was an acryl-coated ferrite carrier with an average particle size of 60 μm, the developing agent was adjusted to a toner concentration of 5 wt %, and evaluation was made under the following evaluation conditions.

| Printer process speed: | 100 | mm/s |
|---|---|---|
| Number of prints: | 150,000 | |
| Fixing roller | | |
| Coating fluororesin: | perfluoroalkoxy resin | |
| Roll pressure: | 2 | kgf/cm² |
| Fluororesin coating | 5 | μm |
| thickness: | | |
| Intermediate layer rubber | 30 | |
| hardness: | | |

| | |
|---|---|
| Intermediate layer | silicone rubber |
| material: | |
| Roller surface temperature: | 170° C. |

The evaluation was made based on the following evaluation criteria.

TABLE 2
(semi-soft roller)

| | Non- | | |
|---|---|---|---|
| | offsetting | | |
| Characteristic | property | Smoothness | Roller life |
| | No offsetting | Image luster | No deterioration of |
| | up to 220° C. | 15 or higher | roller after 150,000 |
| | | | sheets |
| ◯ | No offsetting | Image luster | No deterioration of |
| | up to 200° C. | 8 or higher | roller after 100,000 |
| | | | sheets |
| X | Offsetting at | Image luster | Roller deterioration |
| | 200° C. | less than 8 | at less than 100,000 |
| | | | sheets |

As a result, all of the following characteristics were satisfied.
Non-offsetting property: No offsetting up to 220° C.
Smoothness: An image luster of 18 was realized, providing vivid full color images.
Roller life: No deterioration in characteristics even after printing 150,000 sheets.

For reference, the results of testing a soft roll fixing device are also given.

[Soft roll fixing device (FIG. 3)]

The fixing apparatus comprises a hot roller 22 with an internal heater 21, and a pressure roller 23, and both rollers are equipped with accessory springs 24 on either side, which press the hot roller and the pressure roller together at a pressure of 2 kgf/cm². The roll used as the fixing roll was an aluminum roller surface coated with 20 mm thick silicone rubber 26. Felt 25 was impregnated with a fixing oil and pressure contacted with the fixing roller. The hot roll surface temperature was controlled to 160° C.

(Evaluation conditions)

| | | |
|---|---|---|
| Printer process speed: | 30 | mm/s |
| Number of prints: | 20,000 | |
| Fixing roller | | |
| Silicone rubber coating thickness: | 20 | mm |
| Roll pressure: | 2 | kgf/cm² |

| | |
|---|---|
| Roller surface temperature: | 170° C. |

TABLE 3
(soft roll fixing)

| | Non- | | |
|---|---|---|---|
| | offsetting | | |
| Characteristic | property | Smoothness | Roller life |
| | No offsetting | Image luster | No deterioration of |
| | up to 220° C. | 20 or higher | roller after 20,000 |
| | | | sheets |
| ◯ | No offsetting | Image luster | No deterioration of |
| | up to 200° C. | 10 or higher | roller after 10,000 |
| | | | sheets |
| X | Offsetting at | Image luster | Roller deterioration |
| | 200° C. | less than 10 | at less than 10,000 |
| | | | sheets |

As a result, all of the following characteristics were satisfied.
Non-offsetting property: No offsetting up to 220° C.
Smoothness: An image luster of 23 was realized, providing vivid full color images.
Roller life: No deterioration in characteristics even after printing 20,000 sheets.

### Example 2

Evaluation was made in the same manner as in Example 1, except that dipropenylsuccinic anhydride [R¹ in formula (I) having 6 carbon atoms] was substituted for tetrapropenylsuccinic anhydride [R¹ in formula (I) having 12 carbon atoms] as the acid component in the monomer of the binder resin for the above-mentioned toners 1, 2 and 3, and the same satisfactory characteristics were realized as in Example 1.

### Example 3

Evaluation was made in the same manner as in Example 1, except that octapropenylsuccinic anhydride [R¹ in formula (I) having 24 carbon atoms] was substituted for tetrapropenylsuccinic anhydride [R¹ in formula (I) having 12 carbon atoms] as the acid component in the monomer of the binder resin for the above-mentioned toners 1, 2 and 3, and the same satisfactory characteristics were realized as in Example 1.

Comparative Example 1

Evaluation was made in the same manner as in Example 1, except that propenylsuccinic anhydride [R¹ in formula (1) having 3 carbon atoms] was substituted for tetrapropenylsuccinic anhydride [R¹ in formula (I) having 12 carbon atoms] as the acid component in the monomer of the binder resin for the above-mentioned toners 1, 2 and 3, but offsetting occurred at 200° C. with semi-soft roller fixing.

Comparative Example 2

Evaluation was made in the same manner as in Example 1, except that nonapropenylsuccinic anhydride [R¹ in formula (I) having 27 carbon atoms] was substituted for tetrapropenylsuccinic anhydride [R¹ in formula (I) having 12 carbon atoms] as the acid component in the monomer of the binder resin for the above-mentioned toners 1, 2 and 3, but the image smoothness was poor making it impossible to realize vivid full color images.

### Example 4-26, Comparative Examples 3-18

These examples and comparative examples are summarized in the following Table 4.

Conditions 1 and 2 as used in Table 4 are defined as follows:

Conditions 1 and 2:

| | Condition 1 | | Condition 2 | |
|---|---|---|---|---|
| Printer process | 100 | mm/s | 33 | mm/s |
| speed | | | | |
| Number of prints | 150,000 | | 20,000 | |
| Fixing roller | | | | |
| (Hot roller) | | | | |
| 1) Coating layer | | | | |
| Material | Perfluoralkoxy resin | | Silicone rubber | |
| Thickness | 50 | μm | 20 | mm |
| 2) Intermediate | | | | |
| layer | | | | |
| Material | Silicone rubber | | | |
| Thickness | 1 | mm | | |
| Hardness | 30 | | | |
| Fixing roller | 2 | kgf/cm | 2 | kgf/cm |
| pressure | | | | |

| | | |
|---|---|---|
| Fixing roller | 170° C. | 170° C. |
| surface | | |
| temperature | | |
| Comment | Semi-soft roller | Soft roller |
| | (see FIG. 2) | (see FIG. 3) |

The following Explanatory Table gives data which describes, in summary, the compositions in various Examples and Comparative Examples. The compositions of the toner is the same as in Table 1 and the evaluation is the same as in Example 1. Only the change (difference from Example 1) is listed in the second column, showing that the other features of Example 1 were followed.

| | Polyoxypropylene | | | | | | | | | | | |
|---|---|---|---|---|---|---|---|---|---|---|---|---|
| | (2,2)-2,2-bis(4- | | | | Tetrapropenyl | | | | | | | |
| | hydroxyphenyl) | | Terephthalic | | succinic | | | | Trimellitric | | Propylene | |
| | propane | | acid | | anhydride | | Hydroquinone | | acid | | glycol | |
| Ex. 1 | 680 | g | 120 | g | 100 | g | 0.1 | g | 20 | g | | |
| Ex. 4 | 680 | g | | | 100 | g | 0.1 | g | 20 | g | — | |
| Ex. 5 | 680 | g | 120 | g | 100 | g | 0.1 | g | | | — | |
| Ex. 6 | | | 120 | g | 100 | g | 0.1 | g | 20 | g | 680 | g |
| Ex. 7 | 680 | g | 265 | g | 35 | g | 0.1 | g | 20 | g | — | |
| | | | (82 | mol %)* | (10 | mol %)* | | | (8 | mol %)* | | |
| Ex. 8 | 680 | g | 25 | g | 270 | g | 0.1 | g | 20 | g | — | |
| | | | (12 | mol %)* | (80 | mol %)* | | | (8 | mol %)* | | |
| Comp. | 680 | g | 175 | g | 18 | g | 0.1 | g | 20 | g | | |
| Ex. 3 | | | (87 | mol %)* | (5 | mol %)* | | | (8 | mol %)* | | |
| Comp. | 680 | g | 5 | g | 305 | g | 0.1 | g | 20 | g | | |
| Ex. 4 | | | (2 | mol %)* | (90 | mol %)* | | | (8 | mol %)* | | |
| Ex. 9 | 680 | g | 120 | g | 100 | g | 0.1 | g | 30 | g | | |
| Comp. | 680 | g | 120 | g | 100 | g | 0.1 | g | 40 | g | | |
| Ex. 5 | | | | | | | | | | | | |

*Based on the total acid component.

In Example 10, the polyester resin in Example 1 and the linear polyester resin in Example 5 were mixed in a weight ratio of 7:3. The composition of the toner was the same as in Table 1 and the evaluation was the same as in Example. 1.

Comparative Example 6:

The same as in Condition 1, except that the coating layer and intermediate layer in Condition 1 were not used.

Comparative Example 7:

The same as in Condition 2 except that the coating layer was not used.

Examples 11-24 and Comparative Example 11-16:

The same as in Condition 1 or 2 except for noted ones.

TABLE 4
Examples and Comparative Examples

| | | Characteristics | | | | | | |
|---|---|---|---|---|---|---|---|---|
| | Change | Condition 1 | | | Condition 2 | | | |
| | (difference from | Non- | Smooth- | Roller | Non- | Smooth- | Roller | |
| | Example 1) | offsetting | ness | life | offsetting | ness | life | Comment |
| Ex. 2 | R¹ of formula | * | * | * | * | * | * | More carbon atoms in |
| | (I): C12→C6 | | | | | | | dicarboxylic acid |
| Ex. 3 | R¹ of formula | * | * | * | * | * | * | Fewer carbon atoms |
| | (I): C12→C24 | | | | | | | in dicarboxylic acid |
| Comp. | R¹ of formula | * | * | * | * | * | * | No. of carbon atoms |
| Ex. 1 | (I): C12→C3 | | | | | | | in dicarboxylic acid |
| | | | | | | | | below restricted |
| | | | | | | | | range |
| Comp. | R¹ of formula | * | * | * | * | * | * | No. of carbon atoms |
| Ex. 2 | (I): C12→C27 | | | | | | | in dicarboxylic acid |
| | | | | | | | | above restricted |
| | | | | | | | | range |
| Ex. 4 | Terephthalic | * | 0 | * | * | 0 | * | Proportion of pseudo |
| | acid not used as | | | | | | | crosslinked component increased |
| | polycarboxylic | | | | | | | and dynamic viscoelasticity |
| | acid | | | | | | | improved |
| Ex. 5 | Trimellitic acid | 0 | * | * | * | * | * | Dynamic |
| | not used as | | | | | | | viscoelasticity lowered |
| | polycarboxylic | | | | | | | |
| | acid | | | | | | | |
| Ex. 6 | Propylene glycol | 0 | * | * | 0 | * | * | Dynamic |
| | alone used as | | | | | | | viscoelasticity |
| | dihydric alcohol | | | | | | | lowered |
| Ex. 7 | dicarboxylic | 0 | * | * | 0 | * | * | Proportion of pseudo |
| | acids in formulas | | | | | | | crosslinked component decreased |
| | (I), (II) = 10 mol % | | | | | | | and dynamic |
| | of acid component | | | | | | | viscoelasticity lowered |
| Ex. 8 | dicarboxylic | * | 0 | * | * | 0 | * | Proportion of pseudo |
| | acids in formulas | | | | | | | crosslinked |
| | (I), (II) = 80 mol % | | | | | | | component increased and |
| | of acid component | | | | | | | dynamic viscoelasticity increased |
| Comp. | dicarboxylic | X | * | * | 0 | * | * | Proportion of |
| Ex. 3 | acids in formulas | | | | | | | pseudo crosslinked |
| | (I), (II) = | | | | | | | component too low |
| | 5 mol % of acid | | | | | | | |
| | component | | | | | | | |
| Comp. | dicarboxylic | * | X | * | * | X | * | Proportion of |
| Ex. 4 | acids in formulas | | | | | | | pseudo crosslinked |
| | (I), (II) = 90 mol % | | | | | | | component too high |
| | of acid component | | | | | | | |
| Ex. 9 | Chloroform- | * | 0 | * | * | 0 | * | Chloroform |
| | insoluble portion | | | | | | | insoluble portion |
| | of polyester | | | | | | | increased dynamic |
| | resin = 20 wt % | | | | | | | viscoelasticity |
| Comp. | Chloroform- | * | X | * | * | X | * | Chloroform- |
| Ex. 5 | insoluble portion | | | | | | | insoluble portion |
| | of polyester | | | | | | | increased dynamic |
| | resin = 25 wt % | | | | | | | viscoelasticity too much. |
| Ex. | Linear polyester | 0 | * | * | * | * | * | |
| 10 | resin mixed at 30 | | | | | | | |
| | wt % as binder resin | | | | | | | |
| Comp. | Aluminum roller | 0 | X | * | — | — | — | Image luster was |
| Ex. 6 | used as fixing | | | | | | | reduced with hard |
| | roller under | | | | | | | roller |
| | condition 1 | | | | | | | |
| Comp. | Aluminum roller used | — | — | — | 0 | X | * | Image luster was |
| Ex. 7 | as fixing roller | | | | | | | reduced with |
| | under condition 2 | | | | | | | hard roller |
| Ex. 11 | 2 mm-thick silicone | — | — | — | 0 | 0 | 0 | Roller hardness |
| | rubber coating fixing | | | | | | | increases with |
| | roller under | | | | | | | thinner rubber |
| | condition 2 | | | | | | | thickness |
| Ex. 12 | 30 mm-thick silicone | — | — | — | * | * | * | Proper roller hardness |
| | rubber coating fixing | | | | | | | hardness |
| | roller under | | | | | | | exhibited with |
| | condition 2 | | | | | | | greater rubber thickness |
| Comp. | 35 mm-thick silicone | — | — | — | * | * | * | Wasteful as |
| Ex. 9 | rubber coating fixing | | | | | | | printing |
| | roller under | | | | | | | characteristics are the |
| | condition 2 | | | | | | | same as with 30 mm. |
| Ex. 13 | 1 kgf/cm² fixing | * | 0 | * | * | 0 | * | |
| | roller pressure under | | | | | | | |
| | conditions 1, 2 | | | | | | | |
| Ex. 14 | 4 kgf/cm² fixing | 0 | * | 0 | * | * | 0 | More roller damage |
| | roller pressure under | | | | | | | occurs with higher pressure |
| | conditions 1, 2 | | | | | | | |
| Comp. | 0.5 kgf/cm² fixing | 0 | X | 0 | * | X | 0 | Poor fixing property |
| Ex. 9 | roller pressure under | | | | | | | and no improvement in |
| | conditions 1, 2 | | | | | | | smoothness |
| Comp. | 5 kgf/cm² fixing | 0 | * | X | * | * | X | Pressure too |
| Ex. 10 | roller pressure under | | | | | | | high, reduced |
| | conditions 1, 2 | | | | | | | roller life |
| Ex. 15 | Polytetrafluoro- | * | * | * | — | — | — | |
| | ethylene used as | | | | | | | |
| | coating fluororesin on | | | | | | | |
| | fixing roller under | | | | | | | |
| | condition 1 | | | | | | | |
| Ex. 16 | Conductive fine powder | * | * | * | — | — | — | Increased compatibility with |
| | added as coating | | | | | | | fixing oil, and improved non- |
| | fluororesin on fixing | | | | | | | offsetting property |
| | roller under condition 1 | | | | | | | |
| Ex. 17 | 10 μm film thickness of | 0 | 0 | 0 | — | — | — | Reduced strength with thinner |
| | fluororesin under | | | | | | | film thickness of fluororesin |
| | condition 1 | | | | | | | |
| Ex. 18 | 100 μm film thickness | 0 | 0 | 0 | — | — | — | Increased roller hardness |
| | of fluororesin under | | | | | | | with thicker film thickness |
| | condition 1 | | | | | | | of fluororesin |
| Comp. | 5 μm film thickness of | 0 | 0 | X | — | — | — | Fluororesin prone to peeling |
| Ex. 11 | fluororesin under | | | | | | | |
| | condition 1 | | | | | | | |
| Comp. | 150 μm film thickness | 0 | X | 0 | — | — | — | Roller hardness is high and |
| Ex. 12 | of fluororesin under | | | | | | | smoothness is reduced |
| | condition 1 | | | | | | | |
| Ex. 19 | Fixing roller surface | * | 0 | * | * | 0 | * | Slightly reduced fixing |
| | temperature of 150° C. | | | | | | | property |
| | under conditions 1 and 2 | | | | | | | |
| Ex. 20 | Fixing roller surface | 0 | * | 0 | 0 | * | 0 | Roller life is shortened |
| | temperature of 200° C. under | | | | | | | when roller surface |
| | conditions 1 and 2 | | | | | | | temperature is too high |
| Comp. | No intermediate layer | 0 | X | 0 | — | — | — | Roller hardness is |
| Ex. 13 | employed in fixing roller | | | | | | | increased |
| | under condition 1 | | | | | | | |
| Ex. 21 | Rubber hardness of 10 for | 0 | 0 | 0 | — | — | — | |
| | intermediate layer in fixing | | | | | | | |
| | roller under condition 1 | | | | | | | |
| Ex. 22 | Rubber hardness of 60 for | * | 0 | 0 | — | — | — | |
| | intermediate layer in fixing | | | | | | | |
| | roller under condition 1 | | | | | | | |
| Comp. | Rubber hardness of 5 for | 0 | 0 | X | — | — | — | |
| Ex. 14 | intermediate layer in fixing | | | | | | | |
| | roller under condition 1 | | | | | | | |
| Comp. | Rubber hardness of 60 for | 0 | X | 0 | — | — | — | |
| Ex. 15 | intermediate layer in fixing | | | | | | | |
| | roller under condition 1 | | | | | | | |
| Ex. 23 | Processing speed of 5 mm/s | — | — | — | 0 | * | * | |
| | under condition 2 | | | | | | | |
| Comp. | Processing speed of 2 mm/s | — | — | — | X | * | 0 | |
| Ex. 16 | under condition 2 | | | | | | | |
| Ex. 24 | Processing speed of 1000 | * | 0 | 0 | — | — | — | |
| | mm/s under condition 1 | | | | | | | |

The process for producing the toner was as follows.

[Toner 11 (black)]

| | | | |
|---|---|---|---|
| Binder resin: | polyester resin (softening point: | 92 | pts. by wt. |
| | 100° C.) | | |
| Coloring material: | Black pearls L (Cavot Co.) | 4 | pts. by wt. |
| Charge control agent: | BONTRON E81 (Orient | 2 | pts. by wt. |
| | Chemicals) | | |
| Wax: | Biscoru 660-P (Sanyo Kasei) | 2 | pts. by wt. |

The above composition was mixed and stirred with a ball mill and then melted and kneaded with an extruder heated to 140° C., and after cooling to solidity, a grinder was used for coarse grinding which was followed by fine grinding with a jet mill. The resulting fine powder was sorted with an air classifier to obtain toner of 5-20 μm.

[Toner 12 (yellow)]

| | | | |
|---|---|---|---|
| Binder resin: | polyester resin | 93.5 | pts. by wt. |
| | (softening point: 100° C.) | | |
| Coloring material: | Benzimi | 4 | pts. by wt. |
| | dazolon | | |
| | e-based | | |
| | pigment | | |
| | ' | | |
| | Pigment | | |
| | Yellow | | |
| | 154 | | |
| Charge control agent: | BONTRON E84 | 0.5 | pts. by wt. |
| | (Orient Chemicals) | | |
| Wax: | Biscoru 660-P (Sanyo Kasei) | 2 | pts. by wt. |

The above composition was mixed and stirred with a ball mill and then melted and kneaded with an extruder heated to 140° C., and after cooling to solidity, a grinder was used for coarse grinding which was followed by fine grinding with a jet mill. The resulting fine powder was sorted with an air classifier to obtain toner of 5-20 μm. The toner was then treated with exterior addition of the following titanium dioxide using a Henschel mixer.

| TiO_{2:} | primary particle size | 0.01 | μm |
|---|---|---|---|
| | secondary particle size | 0.3 | μm |
| | Surface treatment agent | octyltrimeth- | |
| | | oxysilane as a | |
| | | silane coupling | |
| | | agent | |
| | Electrical resistance | 10⁸ | Ω · cm |
| | Crystalline form | anatase | |
| | Amount added | 1 | wt % |

Other colored toner was prepared for testing by changing only the yellow toner pigment.

[Toner 13] Magenta toner pigment: quinacridone-based pigment, Pigment Red 122

[Toner 14] Cyan toner pigment: copper phthalocyanine pigment, Pigment Blue 15

TABLE 5
(toner composition)

| Material name | Yellow toner | | Magenta toner | | Cyan toner | |
|---|---|---|---|---|---|---|
| Binder resin | 91 | pts/wt | 91 | pts/wt | 91 | pts/wt |
| Charge control agent | 2 | pts/wt | 2 | pts/wt | 2 | pts/wt |
| Wax | 2 | pts/wt | 2 | pts/wt | 2 | pts/wt |
| Yellow pigment | 5 | pts/wt | — | | — | |
| Magenta pigment | — | | 5 | pts/wt | — | |
| Cyan pigment | — | | — | | 5 | pts/wt |
| Exterior additive | 1 | pt/wt | 1 | pt/wt | 1 | pt/wt |

TABLE 6
(Characteristics of materials)

| Material | Characteristic | Description | |
|---|---|---|---|
| Pigment | Yellow pigment | benzimidazolone-based | |
| | | pigment | |
| | | (Pigment Yellow 154) | |
| | Magenta pigment | quinacridone-based pigment | |
| | | (Pigment Red 122) | |
| | Cyan pigment | copper phthalocyanine | |
| | | pigment | |
| | | (Pigment Blue 15) | |
| | Particle size | 0.5 | μm for all colors |
| Binder | Tm | 100° C. | |
| resin | | | |
| Charge | | zinc complex (BONTRON E-84 | |
| control | | (Orient Chemicals)] | |
| agent | | | |
| Exterior | Core | TiO₂ | |
| additive | Surface treating agent | silane coupling agent | |
| | | (octyltrimethoxysilane) | |
| | Electrical resistance | 10⁸ | Ω · cm |
| | Primary particle size | 0.01 | μm |
| | Secondary particle size | 0.5 | μm |

| | | |
|---|---|---|
| | Crystalline form | anatase |
| Wax | Substance name | polypropylene |

(Carrier)

Ferrite carrier (methyl methacrylate coating) with average particle size of 60 μm, toner concentration: 5 wt %

[Multi-color image forming apparatus (FIG. 1)]

The apparatus used was the one shown in FIG. 1 explained in regard to the first aspect.

### Example31

The above-mentioned toners 11-14 were used for continuous full color printing of 100,000 sheets with the multi-color image forming apparatus mentioned above, and evaluation was made under the following conditions.

| | | |
|---|---|---|
| Printer process speed: | 10 | mm/s |
| Number of prints: | 100,000 | |
| Fixing device (soft roller) | | |
| Silicone rubber thickness: | 15 | mm |

The 4 evaluation levels *, O, Δ and× explained in Table 7 were used for the evaluation criteria.

TABLE 7
Evaluation criteria

| Property | * | ◯ | Δ | X |
|---|---|---|---|---|
| Color | Visual | Visual | — | — |
| balance | observation | observation | | |
| | showed | showed | | |
| | roughly | distorted | | |
| | regular | colored | | |
| | hexagonal | region | | |
| | colored | | | |
| | region | | | |
| Colorability | Saturation | Saturation | Saturation | Saturation |
| | yellow: | yellow: | yellow: | yellow: |
| | >80 | 70-80 | 60-70 | <60 |
| | magenta: | magenta: | magenta: | magenta: |
| | >50 | 40-50 | 30-40 | <30 |
| | cyan: | cyan: | cyan: | cyan: |
| | >40 | 30-40 | 20-30 | <20 |
| Screen | Image | Image | Image | Image |
| printing | concen- | concen- | concen- | concen- |
| | tration: | tration: | tration: | tration: |
| | ≧1, no | ≧1, | <1, | <1, |
| | blotches | blotches | no blotches | blotches |
| Image luster | Luster: >15 | Luster: | Luster: | Luster: <8 |
| | | 10-15 | 8-10 | |
| Environ- | Image color | Color | Color | Color |
| mental | difference | difference | difference | difference |
| character- | at 25° C., | under same | under same | under same |
| istics | 20-80% | conditions: | conditions: | conditions: |
| | RH: <5 | 5-8 | 8-12 | >12 |
| Toner | Virtually | Slight | Slight | Considerable |
| scattering | no visible | visible | visible | visible |
| | toner | toner | toner | toner |
| | contami- | contami- | contami- | contami- |
| | nation | nation | nation | nation |
| | after | after | after | after |
| | continuous | continuous | continuous | continuous |
| | printing of | printing of | printing of | printing of |
| | 100,000 | 100,000 | 10,000 | 10,000 |
| | sheets | sheets | sheets | sheets. |
| Fogging | Print | Print | Print | Print |
| | concen- | concen- | concen- | concen- |
| | tration | tration | tration | tration |
| | in blank | in blank | in blank | in blank |
| | areas: <0.01 | areas: | areas: | areas: |
| | | 0.01-0.1 | 0.1-0.2 | >0.2 |
| Non- | Absolutely | Absolutely | Slight | Offsetting |
| offsetting | no offsetting | no offsetting | offsetting | at 200° C. |
| | up to | up to | up to | |
| | 220° C. | 200° C. | 200° C. | |
| | even after | even after | even after | |
| | continuous | continuous | continuous | |
| | printing of | printing of | printing of | |
| | 100,000 | 100,000 | 100,000 | |
| | sheets. | sheets. | sheets. | |
| Toner | No problems | Slight toner | Considerable | Clogging |
| fluidity | even with | residue in | toner | during |
| | supply of | container | residue in | supply of |
| | 5 kg toner | after supply | container | toner |
| | | of 5 kg toner | after supply | |
| | | | of 5 kg toner | |
| Continuous | Image color | Color | Color | Color |
| printing | difference | difference | difference | difference |
| | of <5 | of 5-8 | of 8-12 | of >12 |
| | after 100,000 | under same | under same | under same |
| | sheets | conditions | conditions | conditions |

Colorability: Vivid colorability realized.
Good image printing: Possible to obtain uniform, solid images without edge effect.
Environment characteristics: No changes in printing characteristics and no color tone variation even with changing environment conditions within 20-80% RH at 250° C.
No toner scattering: No toner scattering due to poor charging, and no toner contamination inside apparatus.
No fogging: No fogging during development due to poor charging.
Image luster: Excellent smoothness and good luster of fixed image realized.
Non-offsetting: No offsetting even after printing 100,000 sheets.
Fluidity: Excellent toner fluidity, allowing smooth toner supply. Excellent developing and transfer properties.
Continuous printing: No variation in printing characteristics after 100,000 sheets.
As a result, all of the characteristics described above were satisfied.

### Example32

The same satisfactory characteristics were realized as in Example 31 upon continuous printing of 100,000 sheets in the same manner as in Example 1 except for changing the quinacridone-based pigment to a naphthol-based pigment (Pigment Red 184) in the above-mentioned toner 13 (magenta toner).

### Example33

The same satisfactory characteristics were realized as in Example 31 upon continuous printing of 100,000 sheets in the same manner as in Example 1 except for changing the quinacridone-based pigment to an azo lake pigment (Pigment Red 57:1) in the above-mentioned toner 13 (magenta toner).

### Examples 21-31 Comparative Examples 21-31

These examples and comparative examples are summarized in the following tables.

TABLE 8

| | | Characteristics | | | | | | | | | | |
|---|---|---|---|---|---|---|---|---|---|---|---|---|
| | Change | | | Screen | | Envir- | Toner | | Non- | Toner | Contin- | |
| | (difference from | Color | Color- | print- | Image | onmental | scat- | Fog- | offset- | fluid- | uous | |
| | Example 1) | balance | ing | ing | luster | chars. | tering | ging | ting | ity | printing | Comment |
| Ex. 32 | Magenta toner | * | * | * | * | * | * | * | * | 0 | * | |
| | changed from | | | | | | | | | | | |
| | quinacridone- | | | | | | | | | | | |
| | based pigment to | | | | | | | | | | | |
| | naphthol-based | | | | | | | | | | | |
| | pigment (Pigment | | | | | | | | | | | |
| | Red 184) | | | | | | | | | | | |
| Ex. 33 | Magenta toner | 0 | * | * | * | * | * | * | * | 0 | * | |
| | changed from | | | | | | | | | | | |
| | quinacridone- | | | | | | | | | | | |
| | based pigment to | | | | | | | | | | | |
| | azo lake pigment | | | | | | | | | | | |
| | (Pigment Red | | | | | | | | | | | |
| | 57:1) | | | | | | | | | | | |
| Ex. 34 | Particle size of | 0 | 0 | * | * | 0 | 0 | 0 | * | 0 | * | Slight |
| | pigment in | | | | | | | | | | | reduction |
| | toner: 0.5 → 1 μm | | | | | | | | | | | in vivid- |
| | | | | | | | | | | | | ness, but |
| | | | | | | | | | | | | no problem |
| Comp. | Particle size of | 0 | X | * | * | Δ | 0 | Δ | * | 0 | X | Poor |
| Ex. 21 | pigment in | | | | | | | | | | | coloring, |
| | toner: 0.5 → 2 μm | | | | | | | | | | | low vivid |
| | | | | | | | | | | | | image |
| Comp. | Amount of | 0 | X | X | X | X | 0 | 0 | Δ | 0 | 0 | Poor |
| Ex. 22 | exterior | | | | | | | | | | | enviromental and |
| | additive (TiO₂): | | | | | | | | | | | continuous |
| | 1 → 0 wt % | | | | | | | | | | | printing properties |
| Ex. 35 | Primary particle | 0 | * | * | * | 0 | 0 | * | * | * | 0 | |
| | size of exterior | | | | | | | | | | | |
| | additive (TiO₂): | | | | | | | | | | | |
| | 0.01 → 0.001 μm, | | | | | | | | | | | |
| | Secondary | | | | | | | | | | | |
| | particle size: | | | | | | | | | | | |
| | 0.5 → 0.3 μm | | | | | | | | | | | |
| Ex. 36 | Primary particle | 0 | * | 0 | * | 0 | * | * | * | 0 | 0 | |
| | size of exterior | | | | | | | | | | | |
| | additive (TiO₂): | | | | | | | | | | | |
| | 0.01 → 0.1 μm, | | | | | | | | | | | |
| | Secondary | | | | | | | | | | | |
| | particle size: | | | | | | | | | | | |
| | 0.5 → 1.0 μm | | | | | | | | | | | |
| Comp. | Primary particle | 0 | 0 | X | * | 0 | Δ | Δ | * | * | 0 | Toner |
| Ex. 23 | size of exterior | | | | | | | | | | | charge too |
| | additive (TiO₂): | | | | | | | | | | | high, poor |
| | 0.01 → 0.005 μm, | | | | | | | | | | | screen |
| | Secondary | | | | | | | | | | | printing |
| | particle size: | | | | | | | | | | | |
| | 0.5 → 0.1 μm | | | | | | | | | | | |
| Comp. | Primary particle | 0 | 0 | X | Δ | Δ | 0 | 0 | 0 | X | Δ | Poor toner |
| Ex. 24 | size of exterior | | | | | | | | | | | fluidity |
| | additive (TiO₂): | | | | | | | | | | | |
| | 0.01 → 0.2 μm, | | | | | | | | | | | |
| | Secondary | | | | | | | | | | | |
| | particle size: | | | | | | | | | | | |
| | 0.5 → 0.5 μm | | | | | | | | | | | |
| Comp. | Primary particle | 0 | 0 | X | Δ | Δ | Δ | 0 | 0 | X | Δ | Very poor |
| Ex. 25 | size of exterior | | | | | | | | | | | toner |
| | additive (TiO₂): | | | | | | | | | | | fluidity |
| | 0.01 → 0.05 μm, | | | | | | | | | | | |
| | Secondary | | | | | | | | | | | |
| | particle size: | | | | | | | | | | | |
| | 0.5 → 1.5 μm | | | | | | | | | | | |
| Ex. 37 | Electrical | 0 | * | * | * | * | * | 0 | * | 0 | * | |
| | resistance of | | | | | | | | | | | |
| | exterior additive | | | | | | | | | | | |
| | (TiO₂): 10⁸ → 10⁶ | | | | | | | | | | | |
| | Ω · cm, | | | | | | | | | | | |
| | Amount added: 1 → | | | | | | | | | | | |
| | 0.1 pts by wt. | | | | | | | | | | | |
| Ex. 38 | Electrical | 0 | * | 0 | * | * | * | * | * | 0 | * | |
| | resistance of | | | | | | | | | | | |
| | exterior additive | | | | | | | | | | | |
| | (TiO₂): 10⁸ → 10¹² | | | | | | | | | | | |
| | Ω · cm, | | | | | | | | | | | |
| | Amount added: 1 → | | | | | | | | | | | |
| | 2.0 pts by wt. | | | | | | | | | | | |
| Comp. | Electrical | 0 | * | * | * | Δ | Δ | Δ | * | 0 | Δ | Much |
| Ex. 26 | resistance of | | | | | | | | | | | fogging |
| | exterior additive | | | | | | | | | | | and toner |
| | (TiO₂): 10⁸ → 10⁵ | | | | | | | | | | | scattering |
| | Ω · cm, | | | | | | | | | | | |
| Comp. | Electrical | 0 | * | Δ | * | 0 | 0 | 0 | * | 0 | Δ | Poor |
| Ex. 27 | resistance of | | | | | | | | | | | screen |
| | exterior additive | | | | | | | | | | | printing |
| | (TiO₂): 10⁸ → 10¹³ | | | | | | | | | | | |
| | Ω · cm, | | | | | | | | | | | |
| Comp. | Crystalline form | 0 | * | * | 0 | Δ | 0 | 0 | * | 0 | Δ | Poor |
| Ex. 28 | of exterior | | | | | | | | | | | continuous |
| | additive (TiO₂): | | | | | | | | | | | printing |
| | anatase → rutile | | | | | | | | | | | |
| Ex. 39 | Surface treatment | 0 | * | * | * | * | * | * | * | * | * | Good |
| | of exterior | | | | | | | | | | | charge |
| | additive (TiO₂): | | | | | | | | | | | stability |
| | n-butyl- | | | | | | | | | | | and fluidity |
| | trimethoxysilane, | | | | | | | | | | | |
| | Secondary | | | | | | | | | | | |
| | particle size: | | | | | | | | | | | |
| | 0.5 → 0.3 | | | | | | | | | | | |
| Comp. | Amount of | 0 | X | X | Δ | X | 0 | 0 | 0 | X | Δ | Poor screen |
| Ex. 29 | exterior | | | | | | | | | | | printing |
| | additive (TiO₂): | | | | | | | | | | | |
| | 1 → 0.05 pts by | | | | | | | | | | | |
| | wt. | | | | | | | | | | | |
| Comp. | Amount of | 0 | 0 | 0 | 0 | Δ | Δ | Δ | * | * | X | Much toner |
| Ex. 30 | exterior | | | | | | | | | | | scattering |
| | additive (TiO₂): | | | | | | | | | | | and fogging |
| | 1 → 2.5 pts by wt. | | | | | | | | | | | |
| Ex. 40 | Charge control | 0 | * | * | * | * | * | * | * | 0 | * | Good |
| | agent: zinc | | | | | | | | | | | continuous and |
| | complex → | | | | | | | | | | | environmental |
| | calixarenes, | | | | | | | | | | | stability |
| | amount: 0.5 pt. | | | | | | | | | | | and safety |
| | by wt. | | | | | | | | | | | |
| Ex. 41 | Charge control | 0 | * | 0 | 0 | 0 | 0 | 0 | * | 0 | 0 | |
| | agent: zinc | | | | | | | | | | | |
| | complex → | | | | | | | | | | | |
| | calixarenes, | | | | | | | | | | | |
| | amount: 0.1 pt. | | | | | | | | | | | |
| | by wt. | | | | | | | | | | | |
| Ex. 42 | Charge control | 0 | * | 0 | 0 | 0 | 0 | 0 | * | 0 | 0 | |
| | agent: zinc | | | | | | | | | | | |
| | complex → | | | | | | | | | | | |
| | calixarenes, | | | | | | | | | | | |
| | amount: 5.0 pts. | | | | | | | | | | | |
| | by wt. | | | | | | | | | | | |
| Comp. | Charge control | 0 | * | 0 | 0 | Δ | Δ | Δ | 0 | 0 | Δ | Poor |
| Ex. 31 | agent: zinc | | | | | | | | | | | charging, |
| | complex → | | | | | | | | | | | fogging |
| | calixarenes, | | | | | | | | | | | |
| | amount: 6.0 pts. | | | | | | | | | | | |
| | by wt. | | | | | | | | | | | |

Aspect 3

The process for producing the toner was as follows.

[Toner 21 (black)]

| | | | |
|---|---|---|---|
| Binder resin: | Polyester resin (softening point: | 92 | pts. by wt. |
| | 100° C., linear) | | |
| Coloring material: | Black pearls L (Cavot Co.) | 4 | pts. by wt. |
| Charge control agent: | BONTRON E81 (Orient | 2 | pts. by wt. |
| | Chemicals) | | |
| Wax: | Biscoru 660-P (Sanyo Kasei) | 2 | pts. by wt. |

The above composition was mixed and stirred with a ball mill and then melted and kneaded with an extruder heated to 140° C., and after cooling to solidity, a grinder was used for coarse grinding which was followed by fine grinding with a jet mill. The resulting fine powder was sorted with an air classifier to obtain toner of 5-20 μm. The toner was then treated with exterior addition of the following material using a Henschel mixer.

| | | | |
|---|---|---|---|
| Hydrophobic silica: | R972 (Nihon Aerodil) | 0.5 | pts. by wt. |

[Toner 22 (yellow)]

| | | | |
|---|---|---|---|
| Binder resin: | Polyester resin (softening | 93.5 | pts. by wt. |
| | point: 100° C., linear, | | |
| | acid value = 3) | | |
| Coloring material: | Benzimidazolone-based | 4 | pts. by wt. |
| | pigment, | | |
| | (Pigment Yellow 154) | | |
| Charge control agent: | BONTRON E84 | 0.5 | pts. by wt. |
| | (Orient Chemicals) | | |
| Wax: | Biscoru 660-P (Sanyo Kasei) | 2 | pts. by wt. |

The above composition was mixed and stirred with a ball mill and then melted and kneaded with an extruder heated to 140° C., and after cooling to solidity, a grinder was used for coarse grinding which was followed by fine grinding with a jet mill. The resulting fine powder was sorted with an air classifier to obtain toner of 5-20 μm. The toner was then treated with exterior addition of the following titanium dioxide using a Henschel mixer.

| | | | |
|---|---|---|---|
| TiO_{2:} | primary particle size | 0.01 | μm |
| | secondary particle size | 0.3 | μm |

| Surface treatment agent | octyltrimethoxy- | |
|---|---|---|
| | silane as a | |
| | silane coupling | |
| | agent | |
| Electrical resistance | 10⁸ | Ω · cm |
| Crystalline form | anatase | |
| Amount added | 1 | wt % |

Other colored toner was prepared for testing by changing only the yellow toner pigment.

[Toner 23] Magenta toner pigment: quinacridone-based pigment, Pigment Red 122

[Toner 24] Cyan toner pigment: copper phthalocyanine pigment, Pigment Blue 15

[Method of measuring toner charge amount]

A 10 g portion of the developing agent was placed in a cylindrical polyethylene bottle, and after stirring at 20 rpm with a ball mill for a prescribed period of time, a charge measuring apparatus (Toshiba Chemical, KK.) was used to measure the charge amount by the blow-off method.

The printer indicated below was used as the apparatus for evaluation of the examples.

(Multi-color image forming apparatus (FIG. 1)]

Same as described earlier.

[Fixing device (FIG. 2)]

The fixing apparatus comprises a hot roller 22 with an internal heater 21, and a pressure roller 23, and both rollers are equipped with accessory springs 24 on either side, which press the hot roller and the pressure roller together at 2 kgf/cm². Felt 25 was impregnated with a fixing oil and pressure contacted with the fixing roller. The hot roll surface temperature was controlled to 160° C.

### Example51

The above-mentioned toner 1 was used with styrene-acryl-coated ferrite with a particle size of 60 μm as the carrier, the charge amount was measured with a toner concentration of 5 wt % and at stirring times of 0, 10, 30, 60, 100, 200, 300 and 600 seconds, and the values of a, b, c, d and τ substituted in equation (1) and the values of χ² and¦q′(0)¦ were as listed below.

a=1.07

b=0.403

c=0.00436

d=39.8

τ=25.8

χ²=0.998(χ²_{0.05}=7.82 for the degree of freedom ν=8−5=3)

¦q′(0)¦=1.49

From these results it is shown that χ² is such that χ²_{0.05}≦7.82 and¦q′(0)¦is at least 1 μC/g•sec.

One kilogram of this developing agent was prepared and placed in the above-mentioned multi-color image forming apparatus for continuous monocolor printing of 100,000 sheets, upon which there was no toner scattering, and thus satisfactory printing characteristics were realized.

### Example52

The above-mentioned toner 22 was used with acryl-coated ferrite with a particle size of 60 μm as the carrier, the charge amount was measured with a toner concentration of 5 wt % and at stirring times of 0, 10, 30, 60, 100, 200, 300 and 600 seconds, and the values of a, b, c, d and τ substituted in equation (1) and the values of χ² and¦q′(0)¦ were as listed below.

a=1.99

b=0.915

c=0.00354

d=24.5

τ=8.34

χ²=0.171(χ²_{0.05}=7.82 for the degree of freedom ν=8−5=3)

¦q′(0)¦=2.91

From these results it is shown that χ² such that χ²_{0.05}≦7.82 and¦q′(0)¦ is at least 1 μC/g•sec.

One kilogram of this developing agent was prepared and placed in the above-mentioned multi-color image forming apparatus for continuous monocolor printing of 100,000 sheets, upon which there was no toner scattering, and thus satisfactory printing characteristics were realized.

### Example53

The above-mentioned toner 23 was used with acryl-coated ferrite with a particle size of 60 μm as the carrier, the charge amount was measured with a toner concentration of 5 wt % and at stirring times of 0, 5, 15, 25, 50, 80, 150, 300, 500 and 780 seconds, and the values of a, b, c, d and τ substituted in equation (1) and the values of χ² and¦q′(0)¦ were determined.

As a result it was found that χ²=5.1 and¦q′(0)¦=2.1 μC/g•sec, and therefore similar to the evaluation results in Example 2, there was no toner scattering and thus satisfactory printing characteristics were realized.

Comparative Example 31

Toner 2 was evaluated in the same manner as in Example 52 except that no exterior additive was used, and this resulted in a¦q′(0)¦ of 0.4 μC/g•sec, a slow charging rate, and toner scattering.

Comparative Example 42

Toner 22 was evaluated in the same manner as in Example 52 except that no exterior additive was used and 100 μm non-coated iron powder was used as the carrier, and this resulted in an χ² of 8, showing poor consistency between the model and the experimental data, while toner scattering occurred even with a¦q′(0)¦ of 1.2 μC/g•sec.

Comparative Example 43

Toner 21 was evaluated in the same manner as in Example 51 except that amino-modified styrene-acryl resin was used as the binder resin, and as a result a charge amount of 0.2 μC/g was exhibited at t=0, while toner adhered to the walls of the hopper, making it impossible to supply the toner in a satisfactory manner.

Comparative Example 44

Toner 22 was evaluated in the same manner as in Example 52 except that no exterior additive was used, and this resulted in a value for a+b of 0.3 μC/g•sec, scattering of the toner, and a saturated charge amount (a×τ)(μC/g) of 70% of the maximum value (μC/g), due to which stable printing characteristics could not be obtained.

Comparative Example 45

Toner 22 was evaluated in the same manner as in Example 52 except that alumina powder with a particle size of 0.01 μm was used, and this resulted in a value for “a” of 0.3 μC/g•sec, and unsatisfactory printing characteristics.

Comparative Example 46

Toner 22 was evaluated in the same manner as in Example 52 except that alumina powder with a particle size of 0.05 μm was used, and this resulted in a value for “b” of 0.1 μC/g•sec, and unsatisfactory printing characteristics.

Comparative Example 47

Toner 22 was evaluated in the same manner as in Example 52 except that alumina powder with a particle size of 0.05 μm and titanium oxide were used, and this resulted in a value for “b” of 2 μC/g•sec, while the printing characteristics varied with the number of sheets printed.

### Example54

When a 40 μm ferrite carrier was used as the carrier for the toner 22, tᵣₒ, the time required for¦q′(t)¦ to become zero, was about 30 seconds, while the saturation charge amount was attained rapidly, and stable printing characteristics were realized.

### Example55

When the exterior additive was added in an amount of 0.5 wt % and a 50 μm ferrite carrier was used as the carrier for the toner 24, tᵣₒ, the time required for¦q′(t)¦ to become zero, was about 180 seconds, while the saturation charge amount was attained rapidly, and stable printing characteristics were realized.

Comparative Example 48

When the exterior additive was added in an amount of 0 wt % and a 50 μm ferrite carrier was used as the carrier for the toner 24, tᵣₒ, the time required for¦q′(t)¦ to become zero, was about 250 seconds, and toner scattering occurred.

### Example56

The developing agent used in Example 52 had a saturated charge amount (a×τ)(μC/g) of 90% of the maximum value (μC/g), by which stable printing characteristics were obtained.

### Example57

The results of measuring the following parameters for the developing agent used in Example 52 under environmental conditions varying within 20-80% RH at 25° C. were:

χ² fluctuation of±8%

¦q′(0)¦ fluctuation of 5%

“a” fluctuation of±7%

“b” fluctuation of±3%

difference between maximum charge amount and saturated charge amount of±6%,

and were thus satisfactory with no variation in the printing characteristics with environmental changes.

Comparative Example 49

The results of measuring the following parameters for the toner 24 in which the exterior additive was added at 0.5 wt % and a 50 μm epoxy-coated ferrite carrier was used as the carrier, under environmental conditions varying within 20-80% RH at 25° C., were:

χ² fluctuation of±15%

¦q′(0)¦ fluctuation of 12%

“a” fluctuation of±11%

“b” fluctuation of±13%

difference between maximum charge amount and saturated charge amount of±50%

variation in difference between saturated charge amount (aτ) and maximum charge amount of 20%, and this large variation in the printing characteristics with environmental changes created problems.

Comparative Example 50

When the exterior additive was added in an amount of 0 wt % and a 50 μm epoxy-coated ferrite carrier was used as the carrier for the toner 24, the difference between the saturated charge amount (aτ) and maximum charge amount was large, and thus the image characteristics varied greatly with the number of sheets printed.

What is claimed is:

1. In the process for forming an image using multi-color electrophotography comprising the step of thermal fixing using a semi-soft roller made by coating the surface of a roller substrate with silicone rubber to a thickness of 2-30 mm and electrophotography, the improvement wherein a binder resin of a color toner is a polyester resin which comprises an alcohol component and an acid component, of which said alcohol component is a dihydric alcohol and said acid component comprises a polyvalent carboxylic acid and at least one selected from dicarboxylic acids represented by the following formulas: 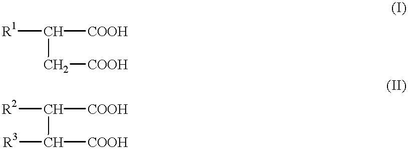
wherein R¹, R², and R³ are saturated or unsaturated hydrocarbon groups of 6-24 carbon atoms, and their acid anhydrides, said color toner using 3 colors of yellow toner, magenta toner and cyan toner, or these 3 color toners with black toner, comprising said binder resin, a charge control agent, a coloring agent and an exterior additive, the image forming process by multi-color electrophotography,
wherein the yellow pigment used as the coloring agent of said yellow toner is a benzimidazolone-based pigment which is dispersed in said yellow toner at an average particle size of 1 μm or less, and the tonier uses titanium dioxide powder surface treated with a silane coupling agent as an exterior additive:
the magenta pigment used as the coloring agent of said magenta toner is dispersed in said magenta toner at an average particle size of 1 μm or less, and the toner uses titanium dioxide powder surface treated with a silane coupling agent as an exterior additive;
the cyan pigment used as the coloring agent of said cyan toner is dispersed in said cyan toner at an average particle size of 1 μm or less, and the toner uses titanium dioxide powder surface-treated with a silane coupling agent as an exterior additive; and
said charge control agent is a calixarene.

2. The image forming process of claim 1, wherein said polyvalent carboxylic acid contains terephthalic acid or its anhydride.

3. The image forming process of claim 1, wherein said polyvalent carboxylic acid contains trimellitic acid or its anhydride.

4. The image forming process of claim 1, wherein said dihydric alcohol is represented by the following formula 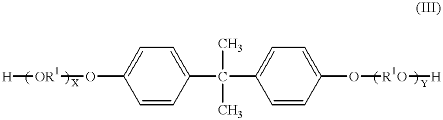
wherein R¹ represents an alkylene group of 2-4 cabon atoms, with a total average value of 2-16.

5. The image forming process of claim 1, wherein the dicarboxylic acid represented by said formula (I) or (II) or its anhydride constitutes 10-80 mole percent of the acid component.

6. The image forming process of claim 1, wherein the chloroform-insoluble portion of said polyester resin constitutes 20 wt % or less of said polyester resin.

7. The image forming process of claim 1, wherein said binder resin contains a mixture of said polyester resin and a linear polyester resin.

8. An image forming process for forming images through heated roll fixation by multi-color electrophotography, using the 3 colors of yellow toner, magenta toner and cyan toner, or these 3 color toners with black toner, comprising a binder resin, a charge control agent, a coloring agent and an exterior additive, the image forming process by multi-color electrophotography being characterized in that
the yellow pigment used as the coloring agent of said yellow toner is a benzimidazolone-based pigment which is dispersed in said yellow toner at an average particle size of 1 1 μm or less, or less, and the toner uses titanium dioxide powder surface treated with a silane coupling agent as an exterior additive;
the magenta pigment used as the coloring agent of said magenta toner is dispersed in said magenta toner at an average particle size of 1 μm or less, and the toner uses titanium dioxide powder surface treated with a silane coupling agent as an exterior additive;
the cyan pigment used as the coloring agent of said cyan toner is dispersed in said cyan toner at an average particle size of 1 μm or less, and the toner uses titanium dioxide powder surface treated with a silane coupling agent as an exterior additive; and
said charge control agent is a calixarene.

9. The image forming process of claim 8, wherein said magenta pigment is a naphthol-based pigment.

10. The image forming process of claim 8, wherein the cyan pigment is a copper phthalocyanine pigment.

11. The image forming process of claim 8, wherein the average particle size of the primary particles of said titanium dioxide powder is 0.001-0.1 μm, and the average particle size of said titanium dioxide powder adhering to the toner surface is 1.0 μm or less.

12. The image forming process of claim 11, wherein the electrical resistance of said titanium dioxide powder is 1×10⁶-1×10¹² Ωcm.

13. The image forming process of claim 12; wherein the crystalline form of said titanium dioxide powder is anatase.

14. The image forming process of claim 8, wherein the silane coupling agent used as the coating agent for said titanium dioxide powder is n-butyltrimethoxysilane.

15. The image forming process of claim 8, wherein said titanium dioxide powder is added to the toner in an amount of 0.1−2.0 wt %.

16. The image forming process of claim 1 which employs color toner according to claim 8.

17. An electrophotographic developing process characterized in that the developing agent used is a two-component developing agent comprising toner and a magnetic carrier wherein, substituting the data from measurement of the toner charge amount¦q(t)′(μC/g) at agitation time t (sec) taken at 6 or more points (n times), including data measured at 0 seconds and at points between 0.30 second, 30-60 seconds, 60-120 seconds and 120-300 seconds, into the following equation (1)
¦q(t)¦=aτ−bτ·exp(−ct)/(cτ−1)−d·exp(−t/τ) (1)
and upon calculating the constants a, b, c, d and× by the least square method, with an× distribution for the degree of freedom (ν=n−5)
$${F}_{υ} ( {χ}^{2} ) = {\int }_{{x}^{2} α}^{∞} {f}_{υ} ( {χ}^{2} ) ⅆ {χ}^{2} = α$$
$$wherein$$
$${f}_{υ} ( {χ}^{2} ) = \frac{{( {χ}^{2} )}^{υ / 2 - 1} {ⅇ}^{- {χ}^{2} / 2}}{{2}^{υ / 2} Γ ( υ / 2 )}$$
χ² is no greater than the value χ²_{0.05} at α=0.05, and¦q′(0) represented by the following equation (2)
¦q′(0)¦=bcτ/(cτ−1)+d/τ (2)
is 1 μC/g•sec or greater.

18. The developing process of claim 17, wherein said two-component developing agent used is a developing agent such that when data from 10 measurements of the toner charge amount at agitation times of 0 seconds and at points between 0-10 seconds, 10-20 seconds, 20-30 seconds, 30-60 seconds, 60-120 seconds and 720-920 seconds are substituted into equation (1) above, and the constants a, b, c, d and t are calculated by the least square method, × measured by the× test is such that×_{0.005}=11.07 or less, and¦q′(0)¦ is 1 μC/g sec or greater.

19. The developing process of claim 17, wherein said two-component developing agent is a developing agent of which the toner charge amount if 0 when t−0.

20. The developing process of claim 17, which employs a developing agent of which “a” and “b” represented in the above formula (1) are such that a+b is 1 μC/g sec or greater.

21. The developing process of claim 17, which employs a developing agent of which “a” represented in the above formula (1L) is 0.5 μC/g sec or greater.

22. The developing process of claim 17, which employs a developing agent of which “b” represented in the above formula (1) is 0.2-2 μC/g sec or greater.

23. The developing process of claim 17, which employs a developing agent such that in the derivative of equation (1) shown as the following equation (3),
¦q′(t)¦=bcτ/[(cτ−1)·exp(−ct)]+d/[τ·exp(t/τ)] (3)
the time tᵣₒ until¦q′(t)¦ in equation (3) becomes zero is 200 seconds or less.

24. The developing process of claim 17, wherein the saturated charge amount (a×t) (μC/g) is 80% of the maximum value (μC/g).

25. The developing process of claim 17, which employs a developing agent of which tₕₒ, the time at which q′(t) in the above equation (2) becomes negative, is 0.9−1.1×tᵣₒ upon variation of the environmental conditions within 20-80% RH at 25° C.
